(19) United States
(12) Patent Application Publication
(10) Pub. No.: US 2023/0044150 A1
(43) Pub. Date: Feb. 9, 2023

(54) COATING COMPOSITION, COATING FILM, ARTICLE, OPTICAL DEVICE, LIGHTING DEVICE, AIR CONDITIONER, AND METHOD FOR PRODUCING COATING FILM

(71) Applicant: Mitsubishi Electric Corporation, Tokyo (JP)

(72) Inventors: Natsumi KOYAMA, Tokyo (JP); Yasuhiro YOSHIDA, Tokyo (JP)

(73) Assignee: Mitsubishi Electric Corporation, Tokyo (JP)

(21) Appl. No.: 17/794,985

(22) PCT Filed: Apr. 8, 2020
(86) PCT No.: PCT/JP2020/015879

§ 371 Date: Jul. 25, 2022

(51) Int. Cl. C09D 1/00; C09D 7/20; C09D 7/40; C09D 127/18

(52) U.S. Cl. CPC C09D 1/00; C09D 7/20; C09D 7/67; C09D 127/18

(57) ABSTRACT

A coating composition contains silica fine particles having an average particle size of 3 nm or more and 25 nm or less, a solvent having a boiling point of 150° C. or higher and 300° C. or lower, and water. The content of the silica fine particles is 0.1 mass% or more and 5 mass% or less. The content of the solvent is 20 mass% or more and 70 mass% or less.

### FIELD

The present disclosure relates to a coating composition containing silica fine particles, a coating film, an article, an optical device, a lighting device, an air conditioner, and a method for producing a coating film.

### BACKGROUND

Various types of dirt such as dust or oil smoke adhere to surfaces of glass of buildings, lenses of outdoor cameras, and covers of lighting devices, and the like. Various techniques for reducing adhesion of such dirt have been proposed. Patent Literature 1 discloses a technique for forming a coating film on a surface using a coating composition that contains an inorganic particle aggregate in which silica fine particles are bound in a chain or beaded shape, and fluororesin particles. In the coating film, many inorganic particle aggregates are present on a surface side, and fluororesin particles are present, so that an uneven structure is formed on the surface of the coating film.

### CITATION LIST

### Patent Literature

Patent Literature 1: Japanese Patent Application Laid-open No. 2016-89147

### SUMMARY

### Technical Problem

However, with the technique described in Patent Literature 1, light scattering occurs due to the uneven structure present on the surface of the coating film, so that the coating film is slightly clouded, which is a problem. For example, when a slightly clouded coating film is formed on a surface of a lens of an outdoor camera, light transmission performance of the lens is deteriorated, and thus it is not desirable. In addition, when a slightly clouded coating film is formed on a surface of a cover of a lighting device, a color tone of a substrate changes, which impairs the design of the lighting device. Therefore, there has been a demand for a coating film having high transparency as compared with conventional ones.

The present disclosure has been made in view of the above, and an object thereof is to obtain a coating composition capable of improving the transparency of a coating film as compared with conventional ones.

### Solution to Problem

In order to solve the above-described problem and achieve the object, the coating composition of the present disclosure contains silica fine particles having an average particle size of 3 nm or more and 25 nm or less, a solvent having a boiling point of 150° C. or higher and 300° C. or lower, and water. The content of the silica fine particles is 0.1 mass% or more and 5 mass% or less. The content of the solvent is 20 mass% or more and 70 mass% or less.

### Advantageous Effects of Invention

The present disclosure achieves an effect that the transparency of a coating film can be improved as compared with conventional ones.

### BRIEF DESCRIPTION OF DRAWINGS

FIG. 1 is a cross-sectional view schematically illustrating an example of a structure of a coating film according to a first embodiment.

FIG. 2 is a cross-sectional view schematically illustrating an example of a method for producing the coating film according to the first embodiment.

FIG. 3 is a cross-sectional view schematically illustrating an example of a procedure of the method for producing the coating film according to the first embodiment.

FIG. 4 is a cross-sectional view schematically illustrating an example of a procedure of the method for producing the coating film according to the first embodiment.

FIG. 5 is a cross-sectional view schematically illustrating an example of a procedure of the method for producing the coating film according to the first embodiment.

FIG. 6 is a front view illustrating an example of an optical device including the coating film according to a second embodiment.

FIG. 7 is a cross-sectional view taken along line VII-VII of FIG. 6.

FIG. 8 is a front view illustrating an example of a lighting device including the coating film according to a third embodiment.

FIG. 9 is a cross-sectional view taken along line IX-IX of FIG. 8.

FIG. 10 is a front view illustrating an example of an air conditioner including the coating film according to a fourth embodiment.

FIG. 11 is a cross-sectional view taken along line XI-XI of FIG. 10.

FIG. 12 is a diagram summarizing formation conditions and evaluation results of coating films of Examples 1 to 17.

FIG. 13 is a diagram summarizing formation conditions and evaluation results of coating films of Comparison examples 1 to 11.

### DESCRIPTION OF EMBODIMENTS

Hereinafter, a coating composition, a coating film, an article, an optical device, a lighting device, an air conditioner, and a method for producing a coating film according to embodiments of the present disclosure will be described in detail with reference to the drawings.

### First Embodiment

### Coating Composition

A coating composition according to a first embodiment contains silica fine particles, a high-boiling-point solvent, and water. The coating composition according to the first embodiment may further contain fluororesin particles and a nonvolatile hydrophilic organic substance. Hereinafter, components contained in the coating composition will be described.

### Silica Fine Particles

Silica fine particles contained in the coating composition according to the first embodiment are a base component of a coating film. By blending the silica fine particles into the coating composition, a hydrophilic surface having high transparency can be formed on the coating film formed of the coating composition. Consequently, it is possible to improve the ability to reduce adhesion of hydrophobic dirt, to cause adhered water to easily spread, and to cause adhered water to easily flow down.

Silica fine particles have a low refractive index as compared with other inorganic particles, and have a value close to values of refractive indices of transparent resins such as plastics, glass, and the like, which are generally used as substrates. When the refractive index of a substrate and that of a coating film are about the same, the coating film is prevented from being appeared white due to light reflection at an interface therebetween and a surface of the coating film, and the color tone of the substrate is less likely to be impaired.

The average particle size of the silica fine particles is preferably 3 nm or more and 25 nm or less, and particularly preferably 4 nm or more and 10 nm or less. Here, the average particle size means a value of the average particle size of primary particles measured by a laser scattering type particle size distribution meter or a dynamic scattering type particle size distribution meter. The primary particle refers to a particle that is a minimum unit of a particle and is not further divided. An aggregate of primary particles in which a plurality of primary particles are aggregated is referred to as a secondary particle. When the average particle size of the silica fine particles is less than 3 nm, the coating film becomes too dense, and an intermolecular force acting between the film surface and dirt increases, so that a desired antifouling property may not be obtained. When the average particle size of the silica fine particles is larger than 25 nm, the unevenness of the surface of the coating film becomes too large, and the coating film is more likely to be clouded. From the above, the average particle size of the silica fine particles is preferably 3 nm or more and 25 nm or less. In particular, when the average particle size of the silica fine particles is 4 nm or more and 10 nm or less, a coating film having appropriate denseness is obtained, and the contact area between the surface of the coating film and dirt is reduced, so that a sufficient antifouling property can be obtained. Here, the antifouling property means a property that dirt is hardly attached or a property that attached dirt is easily removed.

The content of the silica fine particles in the coating composition is preferably 0.1 mass% or more and 5 mass% or less, and preferably 0.5 mass% or more and 2 mass% or less. When the content of the silica fine particles in the coating composition is less than 0.1 mass%, a coating film formed therefrom becomes too thin, so that a desired antifouling property may not be obtained. On the other hand, when the content of the silica fine particles in the coating composition is more than 5 mass%, a coating film becomes too thick, so that the coating film may have cracks and unevenness, and may be more likely to be clouded. From the above, the content of the silica fine particles in the coating composition is preferably 0.1 mass% or more and 5 mass% or less. In particular, when the content of the silica fine particles in the coating composition is 0.5 mass% or more and 2 mass% or less, a uniform coating film having an appropriate thickness can be formed, and a sufficient antifouling property can be obtained.

The silica fine particles having the above characteristics can be prepared in accordance with a known method. For example, colloidal silica prepared from an aqueous solution of sodium silicate or prepared by a solgel method can be used as the silica fine particles. The silica fine particles may have an irregular shape such as a hollow shape, a scaly shape, or a rod shape, other than a spherical shape. When scaly silica fine particles are used, strength of a film obtained therefrom tends to increase. Therefore, for applications requiring abrasion resistance, preferable results are obtained by using scaly silica fine particles. It is also possible to achieve both the strength and the antifouling property of a transparent coating by mixing scaly silica and spherical silica. In addition, silica fine particles linked in a beaded shape may be used.

### High-Boiling-Point Solvent

The high-boiling-point solvent contained in the coating composition according to the first embodiment is a solvent having a boiling point higher than ordinary temperature, and is a solvent having a boiling point of 150° C. or higher and 300° C. or lower as described later. The high-boiling-point solvent controls the drying rate of the coating composition in the course of forming the coating film. Consequently, it is possible to form a liquid film while maintaining the initial concentration of the silica fine particles in the coating composition, and to prevent the silica fine particles from aggregating in the middle of application. Furthermore, by changing the content of the high-boiling-point solvent so as to prolong a drying time, the liquid film after the application can be leveled. A uniform coating film can be obtained by these effects.

The boiling point of the high-boiling-point solvent is preferably 150° C. or higher and 300° C. or lower. When the boiling point of the high-boiling-point solvent is lower than 150° C., the drying rate becomes too rapid, and effects of preventing aggregation of the silica fine particles and leveling the liquid film after the application cannot be obtained. On the other hand, when the boiling point of the high-boiling-point solvent exceeds 300° C., the solvent is more likely to remain in the coating film, and a coating film having desired characteristics cannot be obtained. From the above, the boiling point of the high-boiling-point solvent is preferably 150° C. or higher and 300° C. or lower.

The solubility of the high-boiling-point solvent in water is not particularly limited, but is preferably 70 mass% or more. This is because when the solubility in water is less than 70 mass%, separation from water is more likely to occur.

Examples of the high-boiling-point solvent include ethylene glycol, propylene glycol, ethylene glycol monomethyl ether acetate, ethyl lactate, diethylene glycol dimethyl ether, dipropylene glycol dimethyl ether, diethylene glycol ethyl methyl ether, diethylene glycol isopropyl methyl ether, dipropylene glycol monomethyl ether, diethylene glycol diethyl ether, diethylene glycol monomethyl ether, diethylene glycol butyl methyl ether, tripropylene glycol dimethyl ether, triethylene glycol dimethyl ether, diethylene glycol monobutyl ether, ethylene glycol monophenyl ether, triethylene glycol monomethyl ether, diethylene glycol dibutyl ether, triethylene glycol butyl methyl ether, polyethylene glycol dimethyl ether, tetraethylene glycol dimethyl ether, polyethylene glycol monomethyl ether, and N-methyl-2-pyrrolidone. These can be used alone or in combination of one or more kinds thereof as the high-boiling-point solvent.

The content of the high-boiling-point solvent in the coating composition is 20 mass% or more and 70 mass% or less, and preferably 30 mass% or more and 50 mass% or less. When the content of the high-boiling-point solvent is less than 20 mass%, the effect of preventing aggregation of the silica fine particles and the effect of leveling the liquid film after the application are not sufficiently obtained. When the content of the high-boiling-point solvent is more than 70 mass%, the solubility of the silica fine particles in the coating composition and that of the fluororesin particles that can be optionally contained therein are reduced, and thus the particles are more prone to aggregation. From the above, the content of the high-boiling-point solvent in the coating composition is preferably 20 mass% or more and 70 mass% or less. In particular, when the content of the high-boiling-point solvent in the coating composition is 30 mass% or more and 50 mass% or less, the effect of leveling the liquid film can be obtained while maintaining the dispersion states of the silica fine particles and the fluororesin particles in the liquid film by the coating composition, so that a uniform and highly transparent coating film can be formed.

### Water

Water contained in the coating composition according to the first embodiment is not particularly limited, and tap water, pure water, reverse osmosis (RO) water, deionized water, and the like can be used. The RO water is water obtained by removing impurities from tap water using a reverse osmosis membrane. From the viewpoint of improving the dispersion stability of the silica fine particles in the coating composition, the concentration of ionic impurities such as calcium ions or magnesium ions contained in water is preferably small. Specifically, the concentration of divalent or higher-valent ionic impurities contained in water is preferably 200 ppm or less, and more preferably 50 ppm or less. This is because when the concentration of the divalent or higher-valent ionic impurities is more than 200 ppm, the silica fine particles may be aggregated to cause a decrease in coatability due to a decrease in fluidity of the coating composition, and a decrease in the transparency of the coating film.

The content of water in the coating composition is not particularly limited, but is preferably 25 mass% or more and 80 mass% or less, and more preferably 50 mass% or more and 70 mass% or less. When the content of water is less than 25 mass%, the solubility of the silica fine particles in the coating composition and that of the fluororesin particles that can be optionally contained therein are reduced, and thus the particles may be more prone to aggregation. When the content of water is less than 25 mass%, the coating film becomes thick, and a defect such as a crack may more easily occur. On the other hand, when the content of water exceeds 80 mass%, the amount of solid content in the composition becomes too small, which may make it difficult to efficiently form the coating film. From the above, the content of water in the coating composition is preferably 25 mass% or more and 80 mass% or less. In particular, when the content of water in the coating composition is 50 mass% or more and 70 mass% or less, the dispersion states of the silica fine particles and the fluororesin particles in the liquid film by the coating composition can be maintained, and a uniform and highly transparent coating film with an appropriate thickness can be formed.

### Fluororesin Particles

The coating composition according to the first embodiment can also contain fluororesin particles. By blending the fluororesin particles, a hydrophobic surface can be partially formed on the coating film to be formed. Consequently, the ability to prevent adhesion of dirt can be improved. In addition, lubricity can be imparted by the fluororesin particles to the surface of the coating film to be formed. Consequently, the wear resistance of the coating film can be improved.

The fluororesin particles are not particularly limited, and examples thereof include particles formed from polytetrafluoroethylene (PTFE), tetrafluoroethylene-hexafluoropropylene copolymer (FEP), tetrafluoroethylene-perfluoroalkyl vinyl ether copolymer (PFA), ethylene-tetrafluoroethylene copolymer (ETFE), ethylene-chlorotrifluoroethylene copolymer (ECTFE), polyvinylidene fluoride (PVDF), polychlorotrifluoroethylene (PCTFE), polyvinyl fluoride (PVF), fluoroethylene-vinyl ether copolymer, fluoroethylene-vinyl ester copolymer, copolymers and mixtures thereof, and mixtures of these fluororesins with other resins.

The average particle size of the fluororesin particles is preferably 80 nm or more and 550 nm or less, and more preferably 100 nm or more and 500 nm or less. When the average particle size of the fluororesin particles is less than 80 nm, a hydrophobic portion may not be sufficiently formed on the surface of the coating film. On the other hand, when the particle size of the fluororesin particles exceeds 550 nm, the unevenness of the surface of the coating film becomes large, and dirt is more easily caught, so that a desired antifouling property may not be obtained. In addition, the unevenness of the surface of the coating film may cause light scattering, which may make the coating film clouded. From the above, the average particle size of the fluororesin particles is preferably 80 nm or more and 550 nm or less. In particular, when the average particle size of the fluororesin particles is 100 nm or more and 500 nm or less, a coating film having a hydrophobic surface and appropriate unevenness due to the fluororesin particles is obtained, so that a sufficient antifouling property can be obtained.

In addition, by reducing as much as possible the unevenness of the surface of the coating film to be formed using fluororesin particles in a rod shape or scaly shape, the transparency of the coating film can be improved. Furthermore, with the use of a dispersion of fluororesin particles that contains a low molecular weight component, a solvent, or the like, is flexible at a time of application, and is solidified after application due to volatilization of these components, it is also possible to improve the smoothness and transparency of a film to be obtained.

The fluororesin particles can be prepared in accordance with a known method. Commercially available fluororesin particles in a state of being dispersed in water can be used as a raw material of the coating composition.

The content of the fluororesin particles in the coating composition is preferably 5 mass% or more and 50 mass% or less, and particularly preferably 10 mass% or more and 30 mass% or less with respect to the content of the silica fine particles. When the content of the fluororesin particles with respect to the content of the silica fine particles in the coating composition is less than 5 mass%, the proportion of the hydrophobic surface on the surface of the coating film decreases, and a desired antifouling property may not be obtained. On the other hand, when the content of the fluororesin particles with respect to the content of the silica fine particles is more than 50 mass%, dust tends to adhere to the coating film more easily, which is not preferable. From the above, the content of the fluororesin particles with respect to the content of the silica fine particles in the coating composition is preferably 5 mass% or more and 50 mass% or less. In particular, when the content of the fluororesin particles with respect to the content of the silica fine particles in the coating composition is 10 mass% or more and 30 mass% or less, a coating film having a hydrophilic surface and a hydrophobic surface at an appropriate ratio is obtained, so that a sufficient antifouling property can be obtained.

### Nonvolatile Hydrophilic Organic Substance

The coating composition according to the first embodiment can also contain a nonvolatile hydrophilic organic substance which is an organic substance being nonvolatile and hydrophilic. By blending the nonvolatile hydrophilic organic substance, voids in the formed coating film can be filled, scattering inside the coating film can be reduced, and the transparency of the coating film can be improved. In addition, the coatability of the coating composition can be improved.

The nonvolatile hydrophilic organic substance is not particularly limited, and various nonvolatile organic substances which are not deliquescent can be used. Examples of the nonvolatile hydrophilic organic substance include polyethylene glycol, polypropylene glycol, polytetramethylene glycol, dimethicone copolyol, and mixtures thereof.

As the nonvolatile hydrophilic organic substance, a surfactant can also be used. The surfactant is not particularly limited, but a nonionic surfactant which hardly causes aggregation of silica fine particles or the like is preferable. However, with attention paid to the amount of addition, the pH of the solvent, and the like, an anionic surfactant and a cationic surfactant can also be used.

Examples of the nonionic surfactant include polyoxyethylene alkyl ether, polyoxyethylene alkylphenol ether, polyoxyethylene alkyl ester, polyoxyethylene alkylamine, polyoxyethylene alkyl amide, sorbitan alkyl ester, and polyoxyethylene sorbitan alkyl ester.

Examples of the anionic surfactant include higher alcohol sulfate (Na salt or amine salt), alkyl allyl sulfonate (Na salt or amine salt), alkyl naphthalene sulfonate (Na salt or amine salt), alkyl naphthalene sulfonate condensate, alkyl phosphate, dialkyl sulfosuccinate, rosin soap, and fatty acid salt (Na salt or amine salt).

Examples of the cationic surfactant include octadecylamine acetate, imidazoline derivative acetate, polyalkylene polyamine derivative or a salt thereof, octadecyltrimethylammonium chloride, triethylaminoethylalkylamide halogenide, alkylpyridinium sulfate, and alkyltrimethylammonium halogenide.

The nonvolatile hydrophilic organic substance is not particularly limited, but those having an average molecular weight of 400 or more and 500,000 or less can be used, and those having an average molecular weight of 700 or more and 100,000 or less are preferable. When the average molecular weight is less than 400, adhesion of dust may increase when a large amount of the nonvolatile hydrophilic organic substance is added, which is not preferable. When the average molecular weight exceeds 500,000, the fluidity of the coating liquid decreases, which may make it difficult to perform homogeneous coating. From the above, the nonvolatile hydrophilic organic substance desirably has an average molecular weight of 400 or more and 500,000 or less. In particular, when the average molecular weight of the nonvolatile hydrophilic organic substance is 700 or more and 100,000 or less, appropriate fluidity is obtained, so that it is possible to obtain a coating film having high transparency in which voids have been filled.

The content of the nonvolatile hydrophilic organic substance in the coating composition is preferably 10 mass% or more and 40 mass% or less, and particularly preferably 10 mass% or more and 30 mass% or less with respect to the content of the silica fine particles. When the content of the nonvolatile hydrophilic organic substance with respect to the content of the silica fine particles in the coating composition is less than 10 mass%, it may not be possible to sufficiently fill voids in the coating film to be formed, or the spreadability of the coating composition may be lowered, and thus the transparency of the coating film may be insufficient. On the other hand, when the content of the nonvolatile hydrophilic organic substance with respect to the content of the silica fine particles is more than 40 mass%, the coating film becomes too soft and durability may be insufficient. From the above, the content of the nonvolatile hydrophilic organic substance with respect to the content of the silica fine particles in the coating composition is preferably 10 mass% or more and 40 mass% or less. In particular, when the content of the nonvolatile hydrophilic organic substance in the coating composition is 10 mass% or more and 30 mass% or less, an effect of sufficiently filling voids in the coating film is obtained, so that a coating film having high transparency can be formed.

### Others

The coating composition according to the first embodiment can contain components known in the art from the viewpoint of imparting various properties to the coating composition as long as the effects of the present disclosure are not impaired. Examples of such components include a coupling agent and a silane compound. The blending amounts of these components are not particularly limited as long as the effect of the present disclosure is not impaired, and it is only required to appropriately adjust the amounts depending on the type of components to be used.

The method for producing the coating composition according to the first embodiment containing components such as those described above is not particularly limited, and can be performed in accordance with a method known in the art. Specifically, the coating composition can be prepared by blending, mixing and stirring the above-described components.

Next, a coating film prepared using the above coating composition will be described.

### Coating Film

The coating composition according to the first embodiment is applied onto a substrate and dried to thereby form a coating film.

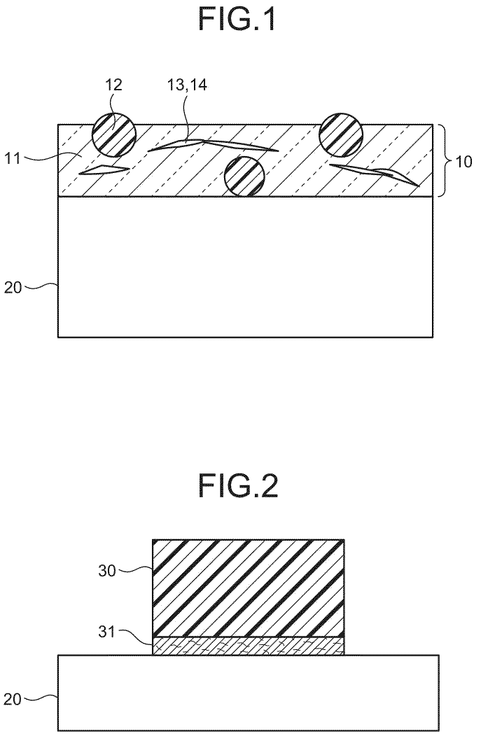

FIG. 1 is a cross-sectional view schematically illustrating an example of a structure of a coating film according to the first embodiment. Here, a case will be described as an example where the coating composition contains silica fine particles, a high-boiling-point solvent, water, fluororesin particles, and a nonvolatile hydrophilic organic substance. A coating film 10 is disposed on a substrate 20, and includes a silica fine particle layer 11 formed by aggregation of silica fine particles, and fluororesin particles 12 disposed in a state of being dispersed in the silica fine particle layer 11. Some of the fluororesin particles 12 are exposed on a surface of the coating film 10, that is, a surface of the silica fine particle layer 11, and others are not exposed. That is, the fluororesin particles 12 are disposed in a state of being partially exposed on the surface of the coating film 10 and being dispersed in the silica fine particle layer 11.

FIG. 1 schematically illustrates cracks 13 each of which is an example of a defect formed by aggregation of silica fine particles when a liquid film of the applied coating composition is dried. In practice, not clear cracks 13 but small voids are often formed. Conventionally, these defects cause light scattering and cloudiness of a film. However, in the coating film 10 according to the first embodiment, these defects are filled with a nonvolatile hydrophilic organic substance 14. Consequently, light scattering is reduced, and the transparency of the coating film 10 is increased. In addition, by the nonvolatile hydrophilic organic substance 14 being added, an effect of reducing the occurrence of these defects itself is also obtained.

As illustrated in FIG. 1, the surface of the coating film 10 according to the first embodiment includes both a hydrophilic portion attributable to the silica fine particles and a hydrophobic portion attributable to the fluororesin particles 12.

As will be described later, the coating composition according to first embodiment contains a high-boiling-point solvent, so that a time from when the coating composition is applied onto the substrate 20 to form a liquid film to when the liquid film is dried to form the coating film 10 is long as compared with conventional ones. Therefore, the liquid film after the application is leveled, and in that state, the coating film 10 is formed. As a result, the coating film 10 is obtained in which the unevenness of the surface has been smoothed, and the transparency can be improved as compared with conventional ones.

The film thickness of the coating film 10 is preferably 20 nm or more and 250 nm or less. When the film thickness is less than 20 nm, the coating film 10 is too thin to obtain a desired antifouling property. When the film thickness is more than 250 nm, the unevenness of the surface of the coating film 10 increases, and the surface may be clouded. From the above, the film thickness of the coating film 10 is preferably 20 nm or more and 250 nm or less. When the film thickness of the coating film 10 is 80 nm or more and 150 nm or less, particularly when around 100 nm, an antireflection function can be imparted to the coating film 10, and the transmittance of the substrate 20 onto which the coating film 10 is applied can be improved.

### Substrate

The substrate is a member on which a coating film is to be formed. In one example, the substrate is a member constituting an article. As the substrate, transparent glass or transparent plastic can be used. When a coating film is formed on a transparent substrate, besides prevention of deterioration in the transparency of the substrate, an antireflection effect is obtained by appropriately designing the film thickness of the coating film, and thus light transmittance can be improved. When a coating film is formed on an opaque substrate, there is an advantage that a treatment that does not change the color tone of the substrate can be performed. In a case of a glossy surface, an effect of improving the depth or vividness of a color can also be obtained by the above-described antireflection effect.

### Production Method

FIG. 2 is a cross-sectional view schematically illustrating an example of a method for producing the coating film according to the first embodiment. A cloth-like object 31 impregnated with the coating composition is fixed to a block 30 which is a coater, and a surface on which the cloth-like object 31 is fixed is brought into close contact with the substrate 20 and slid, and thereby the coating composition is applied onto the substrate 20. Consequently, a liquid film composed of the coating composition is formed on the substrate 20. By combining the cloth-like object 31 and the block 30, a small amount of the coating composition can be applied onto the substrate 20 while applying uniform pressure to the cloth-like object 31, and a uniform coating film can be formed.

The thickness of the cloth-like object 31 is preferably 5 mm or less. This is because when the thickness is more than 5 mm, the impregnation amount of the coating composition becomes too large, so that the coating composition cannot be uniformly applied in some cases. Here, the cloth-like object 31 refers to an assembly of fibers, such as a woven fabric, a nonwoven fabric, or paper. A material for the cloth-like object 31 is not particularly limited as long as the material can be impregnated with the coating composition. An example of the cloth-like object 31 is a cloth made of rayon. Note that the generation of fiber wastes results in defects in the coating, so that those containing as little short fibers as possible are preferable.

The shape of the block 30 is not particularly limited, but is preferably a shape that enables the block 30 to slide along the surface of the substrate 20. That is, it is preferable to use the block 30 having a face of which a shape follows the surface of the substrate 20.

A material for the block 30 is not particularly limited. In one example, the material for the block 30 is polycarbonate. As the material for the block 30, a material that can be impregnated with the coating composition can also be used. Sponges of various materials having communication pores can be each used as the block 30, and regarding pores of such sponges, the pore size is preferably 0.05 mm or more and 2 mm or less, and more preferably 0.1 mm or more and 1.5 mm or less. When the pore size is less than 0.05 mm, it is difficult to sufficiently apply a coating composition. When the pore size exceeds 2 mm, the coating amount of the coating composition becomes too large, and the liquid film tends to be nonuniform, which is not preferable. From the above, regarding pores of such sponges, the pore size is preferably 0.05 mm or more and 2 mm or less.

The coating method described above is a method for stably applying the coating composition to a wide area, but as the coating method, an immersion method, a coating method using a brush, a spray coating method, a coating method using various coaters, and the like can be used in addition to the above method. The coating composition can also be applied by being poured over the substrate 20.

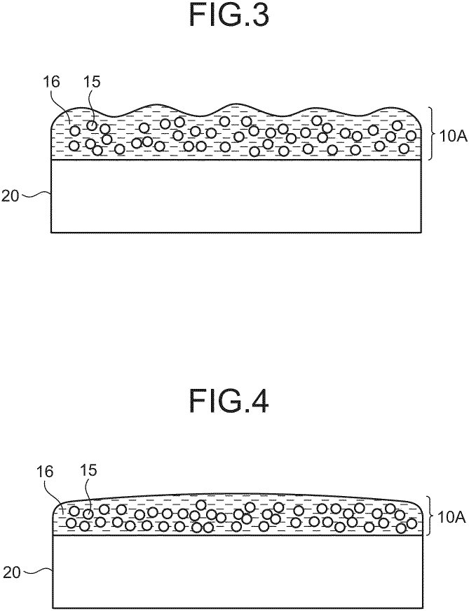

FIGS. 3 to 5 are each a cross-sectional view schematically illustrating an example of a procedure of the method for producing the coating film according to the first embodiment. First, a liquid film forming step of applying a coating composition onto a substrate to form a liquid film is performed. FIG. 3 illustrates an initial state of a liquid film 10A immediately after the coating composition is applied onto the substrate 20 in FIG. 2. As illustrated in FIG. 3, in the initial state, the thickness of the liquid film 10A formed of the applied coating composition is not uniform. In addition, in the liquid film 10A, silica fine particles 15 are dispersed without being aggregated in a solvent 16. Subsequently, a drying step of drying the liquid film 10A in that state is performed.

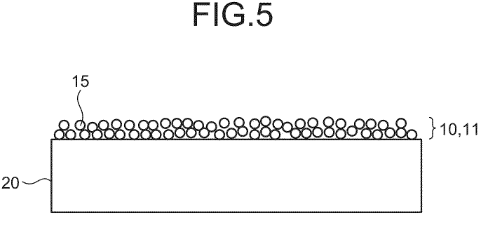

Since the coating composition according to the first embodiment contains a high-boiling-point solvent, the solvent 16 in the coating composition does not volatilize immediately after application, and the solvent 16 volatilizes over a period of time corresponding to the content of the high-boiling-point solvent. During the period, as illustrated in FIG. 4, the liquid film 10A is gradually leveled, so that an upper surface of the liquid film 10A becomes flat. In addition, at that time, the silica fine particles 15 are not aggregated in the liquid film 10A, and the dispersion state thereof is maintained.

Thereafter, when the solvent 16 is finally dried, the silica fine particles 15 are aggregated and the coating film 10 containing the silica fine particle layer 11 is formed as illustrated in FIG. 5.

As a method for drying the coating composition, it is important not to cause temperature variation on the surface of the liquid film 10A obtained by the coating. After the application, it is preferable to perform natural drying. When the drying is accelerated by airflow, it is preferable not to use an airflow of which temperature is higher than the temperature of the substrate 20 by 15° C. or more. When an airflow of which the temperature is higher than the temperature of the substrate 20 by 15° C. or more is used, temperature variation occurs on the surface of the liquid film 10A obtained by the coating, which makes the coating film 10 to be obtained after drying nonuniform. The speed of the airflow is not particularly limited, but is preferably 25 m/sec or less. This is because when the speed of the airflow exceeds 25 m/sec, the liquid film 10A before drying is disturbed, and a uniform coating film 10 may not be obtained.

In the first embodiment, the coating composition contains silica fine particles, a high-boiling-point solvent, and water. The average particle size of the silica fine particles is 3 nm or more and 25 nm or less, and the content of the silica fine particles in the coating composition is 0.1 mass% or more and 5 mass% or less. The boiling point of the high-boiling-point solvent is 150° C. or higher and 300° C. or lower, and the content of the high-boiling-point solvent in the coating composition is 20 mass% or more and 70 mass% or less. Consequently, when the coating composition is applied onto the substrate, the drying speed of the liquid film formed of the applied coating composition is slow as compared with a conventional case where the content of a high-boiling-point solvent is smaller than the content of the high-boiling-point solvent described above, and the liquid film is leveled by the time the solvent in the liquid film is dried. By the leveled liquid film being dried, a coating film having a uniform thickness is obtained. In the coating film, the uneven structure on the surface is reduced, and thereby light scattering due to the uneven structure is also reduced. As a result, there is an effect that a highly transparent coating film can be formed as compared with conventional ones.

### Second Embodiment

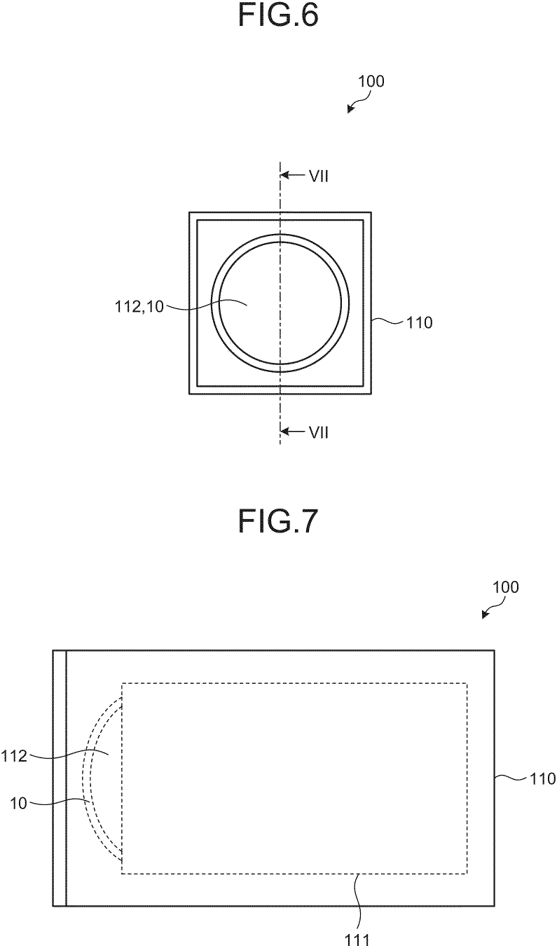

In a second embodiment, a case will be described where the coating film described in the first embodiment is formed on an optical device which is an article. FIG. 6 is a front view illustrating an example of an optical device including the coating film according to the second embodiment, and FIG. 7 is a cross-sectional view taken along line VII-VII of FIG. 6. In the second embodiment, a camera 100 is exemplified as an example of the optical device. The camera 100 includes, in a housing 110, a camera main body unit 111 and a lens 112. When the camera 100 is used indoors and outdoors, dirt may adhere to a surface of the lens 112. Therefore, by forming the coating film 10 described in the first embodiment on the surface of the lens 112, it is possible to prevent adhesion of dirt for a long period of time without affecting an image to be captured by the camera 100.

In the second embodiment, the coating film 10 is formed on the lens 112 of the camera 100. Since the coating film 10 has high transparency as compared with conventional ones, it is possible to expect light condensing performance of the lens 112 equivalent to that before the coating film 10 is applied. In addition, by adjusting the film thickness of the coating film 10 so as to have an antireflection function, the transmittance of the lens 112 to which the coating film 10 is applied can be improved.

### Third Embodiment

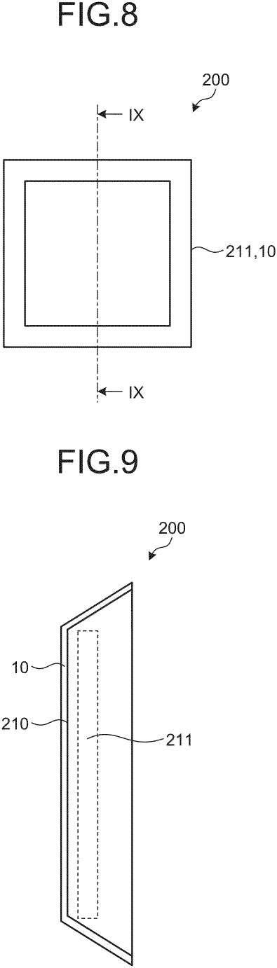

In a third embodiment, a case will be described where the coating film described in the first embodiment is formed on a lighting device which is an article. FIG. 8 is a front view illustrating an example of a lighting device including the coating film according to the third embodiment, and FIG. 9 is a cross-sectional view taken along line IX-IX of FIG. 8. In the third embodiment, a lighting device 200 includes a main body unit 210 that emits light, and a light cover 211 that covers the main body unit 210. When the lighting device 200 is used indoors and outdoors, dirt may adhere to a surface of the light cover 211. Therefore, by forming the coating film 10 described in the first embodiment on the surface of the light cover 211, it is possible to prevent adhesion of dirt for a long period of time without affecting illuminance.

In the third embodiment, the coating film 10 is formed on the light cover 211 of the lighting device 200. Since the coating film 10 has high transparency as compared with conventional ones, it is possible to expect light transmitting performance of the light cover 211 equivalent to that before the coating film 10 is applied.

### Fourth Embodiment

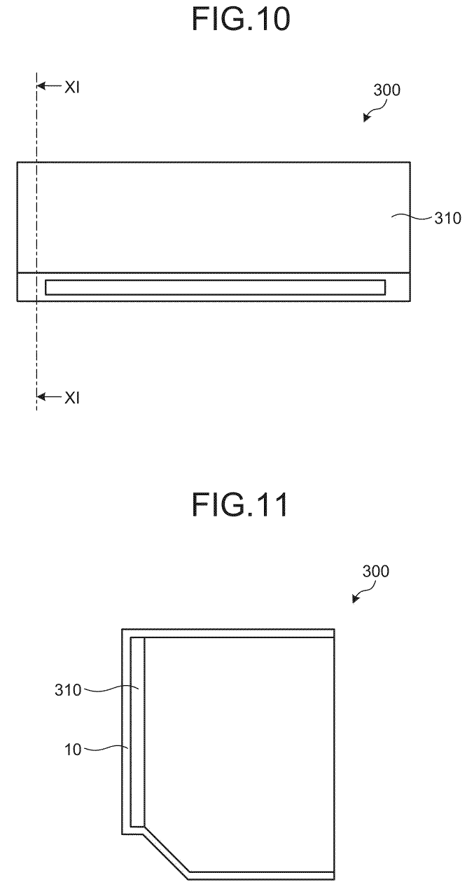

In a fourth embodiment, a case will be described where the coating film described in the first embodiment is formed on an air conditioner which is an article. FIG. 10 is a front view illustrating an example of an air conditioner including the coating film according to the fourth embodiment, and FIG. 11 is a cross-sectional view taken along line XI-XI of FIG. 10. In the fourth embodiment, in one example, an air conditioner 300 is a device that is mounted in a room, takes in outdoor air and supplies the air into the room, and exhausts room air to the outdoors. The air conditioner 300 includes a housing 310 that covers a main body unit (not illustrated) that supplies and exhausts air to and from the room. When the air conditioner 300 is used indoors, dirt may adhere to a surface of the housing 310. Therefore, by forming the coating film 10 described in the first embodiment on the surface of the housing 310, it is possible to prevent adhesion of dirt for a long period of time without changing the appearance of a product.

In the fourth embodiment, the coating film 10 is formed on the housing 310 of the air conditioner 300. Since the coating film 10 has high transparency as compared with conventional ones, it is possible to maintain a color tone of the housing 310 equivalent to that before the coating film 10 is applied.

### EXAMPLES

Hereinafter, details of the present disclosure will be described with reference to Examples and Comparative Examples, but the present disclosure is not limited thereto.

### Method for Preparing Coating Composition and Method for Forming Coating Film

### Example 1

Colloidal silica (manufactured by Nissan Chemical Industries, Ltd., ST-O) containing silica fine particles having an average particle size of 12 nm, diethylene glycol monobutyl ether having a boiling point of 230° C. as a high-boiling-point solvent, and deionized water as water are blended, and mixed and stirred to prepare a coating composition. In the coating composition, the content of the silica fine particles is 1 mass%, the content of diethylene glycol monobutyl ether is 50 mass%, and the content of deionized water is the balance.

The obtained coating composition is impregnated into a nonwoven fabric (manufactured by Kuraray Kuraflex Co., Ltd., product name: KURACLEAN (registered trademark) Wiper, fiber used: rayon) and the nonwoven fabric is fixed to a block made of polycarbonate. A surface of the nonwoven fabric is brought into close contact with a glass substrate (50 mm×50 mm×1 mm) and slid, and then drying is performed at 25° C. for 24 hours to form a coating film.

### Example 2

A coating composition is prepared similarly to Example 1 except that the content of diethylene glycol monobutyl ether as the high-boiling-point solvent is changed to 20 mass%. In addition, a coating film is formed on a glass substrate similarly to Example 1.

### Example 3

A coating composition is prepared similarly to Example 1 except that the content of diethylene glycol monobutyl ether as the high-boiling-point solvent is changed to 21 mass%. In addition, a coating film is formed on a glass substrate similarly to Example 1.

### Example 4

A coating composition is prepared similarly to Example 1 except that the content of diethylene glycol monobutyl ether as the high-boiling-point solvent is changed to 55 mass%. In addition, a coating film is formed on a glass substrate similarly to Example 1.

### Example 5

A coating composition is prepared similarly to Example 1 except that the content of diethylene glycol monobutyl ether as the high-boiling-point solvent is changed to 69 mass%. In addition, a coating film is formed on a glass substrate similarly to Example 1.

### Example 6

A coating composition is prepared similarly to Example 1 except that the content of diethylene glycol monobutyl ether as the high-boiling-point solvent is changed to 70 mass%. In addition, a coating film is formed on a glass substrate similarly to Example 1.

### Example 7

A coating composition is prepared similarly to Example 1 except that instead of diethylene glycol monobutyl ether as the high-boiling-point solvent, dipropylene glycol dimethyl ether having a boiling point of 171° C. is used. In addition, a coating film is formed on a glass substrate similarly to Example 1.

### Example 8

A coating composition is prepared similarly to Example 1 except that the content of the silica fine particles is changed to 0.2 mass%. In addition, a coating film is formed on a glass substrate similarly to Example 1.

### Example 9

A coating composition is prepared similarly to Example 1 except that the content of the silica fine particles is changed to 4 mass%. In addition, a coating film is formed on a glass substrate similarly to Example 1.

### Example 10

A coating composition is prepared similarly to Example 1 except that the average particle size of the silica fine particles is changed to 5 nm. In addition, a coating film is formed on a glass substrate similarly to Example 1.

### Example 11

A coating composition is prepared similarly to Example 1 except that the average particle size of the silica fine particles is changed to 20 nm. In addition, a coating film is formed on a glass substrate similarly to Example 1.

### Example 12

A coating composition is prepared similarly to Example 1 except that PTFE particles (manufactured by Du Pont-Mitsui Fluorochemicals Co., Ltd., product name: 31-JR) are added as fluororesin particles in an amount of 10 mass% with respect to the silica fine particles. The average particle size of the PTFE particles is 0.25 µm. In addition, a coating film is formed on a glass substrate similarly to Example 1.

### Example 13

A coating composition is prepared similarly to Example 1 except that PTFE particles (manufactured by Du Pont-Mitsui Fluorochemicals Co., Ltd., product name: 31-JR) are added as fluororesin particles in an amount of 40 mass% with respect to the silica fine particles. The average particle size of the PTFE particles is 0.25 µm. In addition, a coating film is formed on a glass substrate similarly to Example 1.

### Example 14

A coating composition is prepared similarly to Example 1 except that polyethylene glycol (manufactured by Tokyo Chemical Industry Co., Ltd., product name: Polyethylene Glycol 400) is added as a nonvolatile hydrophilic organic substance in an amount of 15 mass% with respect to the silica fine particles. The average molecular weight of the polyethylene glycol is 380 or more and 420 or less. In addition, a coating film is formed on a glass substrate similarly to Example 1.

### Example 15

A coating composition is prepared similarly to Example 1 except that polyethylene glycol (manufactured by Tokyo Chemical Industry Co., Ltd., product name: Polyethylene Glycol 400) is added as a nonvolatile hydrophilic organic substance in an amount of 35 mass% with respect to the silica fine particles. The average molecular weight of the polyethylene glycol is 380 or more and 420 or less. In addition, a coating film is formed on a glass substrate similarly to Example 1.

### Example 16

A coating film is formed similarly to Example 1 except that the coating composition of Example 1 is applied onto an acrylic substrate (acrylonitrile butadiene styrene (ABS), 50 mm×50 mm×2 mm).

### Example 17

The coating composition of Example 1 is spray-applied onto a glass substrate (50 mm×50 mm×1 mm) and then dried at 25° C. for 24 hours to form a coating film.

### Comparative Example 1

A coating composition is prepared similarly to Example 1 except that the content of diethylene glycol monobutyl ether as the high-boiling-point solvent is changed to 15 mass%. In addition, a coating film is formed on a glass substrate similarly to Example 1.

### Comparative Example 2

A coating composition is prepared similarly to Example 1 except that the content of diethylene glycol monobutyl ether as the high-boiling-point solvent is changed to 19 mass%. In addition, a coating film is formed on a glass substrate similarly to Example 1.

### Comparative Example 3

A coating composition is prepared similarly to Example 1 except that the content of diethylene glycol monobutyl ether as the high-boiling-point solvent is changed to 71 mass%. In addition, a coating film is formed on a glass substrate similarly to Example 1.

### Comparative Example 4

A coating composition is prepared similarly to Example 1 except that the content of diethylene glycol monobutyl ether as the high-boiling-point solvent is changed to 75 mass%. In addition, a coating film is formed on a glass substrate similarly to Example 1.

### Comparative Example 5

A coating composition is prepared similarly to Example 1 except that instead of diethylene glycol monobutyl ether as the high-boiling-point solvent, ethanol having a boiling point of 87° C. is used. In addition, a coating film is formed on a glass substrate similarly to Example 1.

### Comparative Example 6

A coating composition is prepared similarly to Example 1 except that lithium silicate (manufactured by Nissan Chemical Industries, Ltd., product name: Lithium Silicate 45) is used instead of the silica fine particles. In addition, a coating film is formed on a glass substrate similarly to Example 1.

### Comparative Example 7

A coating composition is prepared similarly to Example 1 except that the average particle size of the silica fine particles is changed to 30 nm. In addition, a coating film is formed on a glass substrate similarly to Example 1.

### Comparative Example 8

A coating composition is prepared similarly to Example 1 except that the content of the silica fine particles is changed to 0.05 mass%. In addition, a coating film is formed on a glass substrate similarly to Example 1.

### Comparative Example 9

A coating composition is prepared similarly to Example 1 except that the content of the silica fine particles is changed to 7 mass%. In addition, a coating film is formed on a glass substrate similarly to Example 1.

### Comparative Example 10

A coating composition is prepared similarly to Example 1 except that PTFE particles (manufactured by Du Pont-Mitsui Fluorochemicals Co., Ltd., product name: 31-JR) are added as fluororesin particles in an amount of 60 mass% with respect to the silica fine particles. The average particle size of the PTFE particles is 0.25 µm. In addition, a coating film is formed on a glass substrate similarly to Example 1.

### Comparative Example 11

A coating composition is prepared similarly to Example 1 except that polyethylene glycol (manufactured by Tokyo Chemical Industry Co., Ltd., product name: Polyethylene Glycol 400) which is a nonvolatile hydrophilic organic substance is added in an amount of 50 mass% with respect to the silica fine particles. The average molecular weight of the polyethylene glycol is 380 or more and 420 or less. In addition, a coating film is formed on a glass substrate similarly to Example 1.

### Method for Evaluating Coating Film

The film thicknesses of the coating films formed of the coating compositions of Examples 1 to 15 and Comparative Examples 1 to 11 and the coating films formed of the coating compositions of Examples 16 and 17 are measured, and the transparency and antifouling properties thereof are evaluated.

### Measurement of Film Thickness

A part of a coating film formed on a substrate is scraped, and a step between the coating film and the substrate is measured using a 3D measuring laser microscope (manufactured by Olympus Corporation), thereby measuring the film thickness. The measurement results of the film thicknesses of the coating films are classified in accordance with the following criteria.
1: Film thickness of less than 20 nm
2: Film thickness of 20 nm or more and 120 nm or less
3: Film thickness of more than 120 nm and 250 nm or less
4: Film thickness of more than 250 nm

### Evaluation of Transparency

The hazes of the coating films are measured using a haze gard i (manufactured by BYK-Gardner). The measurement results of the hazes of the coating films are evaluated in accordance with the following criteria, and when the haze is less than 4%, it is determined that the transparency is high.
1: Haze of less than 2%
2: Haze of 2% or more and less than 3%
3: Haze of 3% or more and less than 4%
4: Haze of 4% or more

### Evaluation of Antifouling Property

As antifouling performance, an adhesion property of dust which is a hydrophilic fouling substance with respect to a coating film is evaluated. Specifically, under the conditions of a temperature of 25° C. and a humidity of 50%, Kanto loam dust which is a Japanese Industrial Standards (JIS) test powder having a central particle size in a range of 1 µm or more and 3 µm or less is blown onto a coating film with air. Thereafter, the Kanto loam dust blown onto the coating film is transferred to a mending tape (manufactured by Sumitomo 3M Limited). Regarding another transparent substrate to which the tape with the dust transferred thereon is attached, absorbance at a wavelength of 550 nm is measured with a spectrophotometer (manufactured by Shimadzu Corporation, product name: UV-3100PC). The absorbance is evaluated in accordance with the following criteria, and when the absorbance is less than 0.3, it is determined that the antifouling property is high.
1: Absorbance of less than 0.1
2: Absorbance of 0.1 or more and less than 0.2
3: Absorbance of 0.2 or more and less than 0.3
4: Absorbance of 0.3 or more

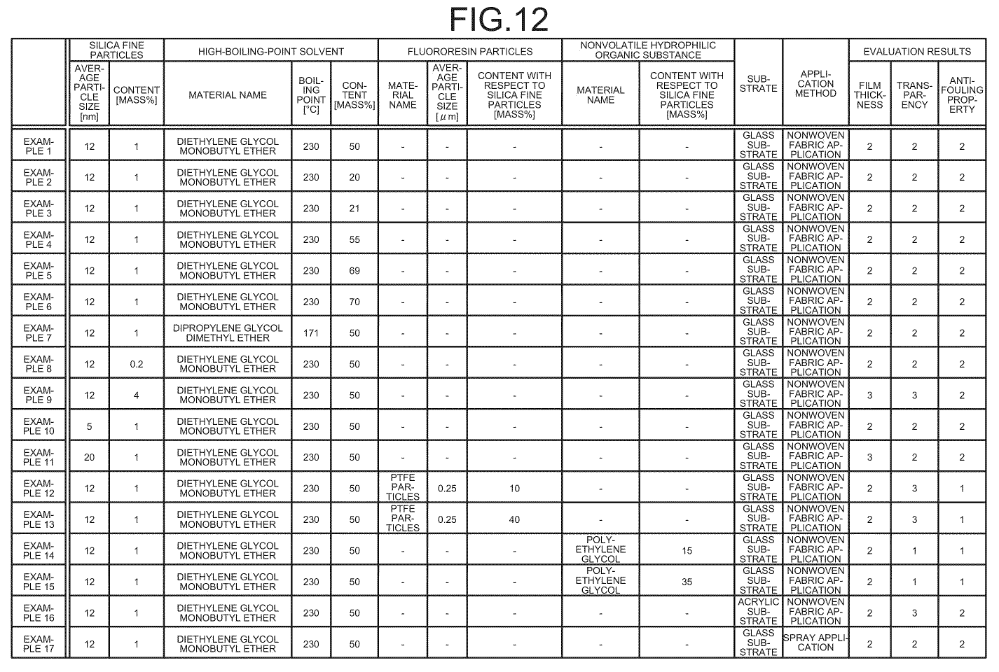

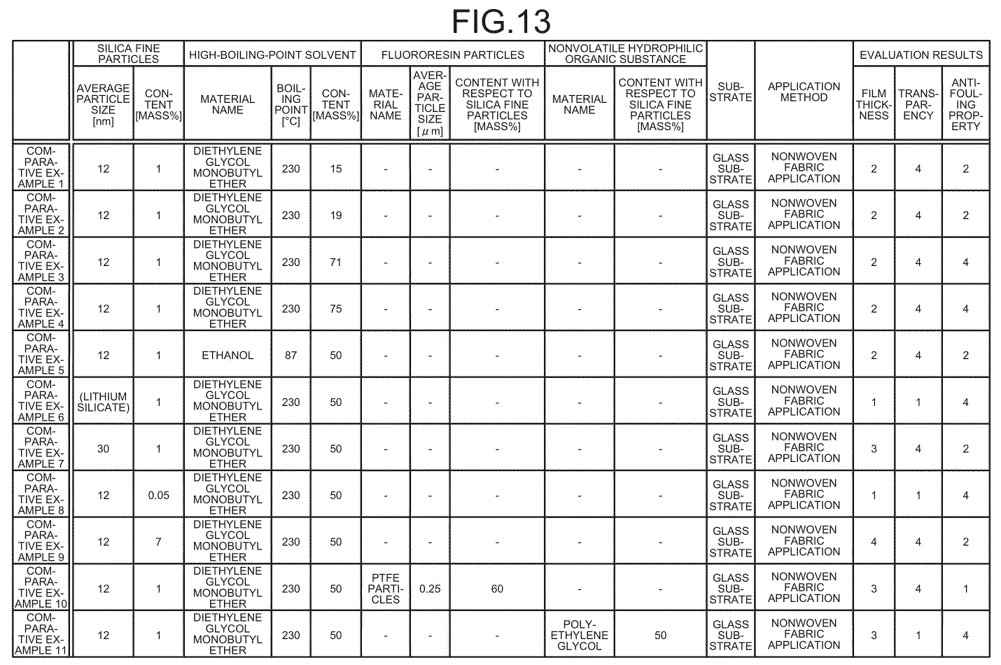

FIG. 12 is a diagram summarizing formation conditions and evaluation results of coating films of Examples 1 to 17. FIG. 13 is a diagram summarizing formation conditions and evaluation results of coating films of Comparison examples 1 to 11.

As illustrated in FIG. 12, in the coating compositions of Examples 1 to 11, the average particle sizes of the silica fine particles are in a range of 3 nm or more and 25 nm or less, and the contents of the silica fine particles in the coating compositions are in a range of 0.1 mass% or more and 5 mass% or less. In the coating compositions of Examples 1 to 11, the boiling points of the high-boiling-point solvents are in a range of 150° C. or higher and 300° C. or lower, and the contents of the high-boiling-point solvents in the coating compositions are in a range of 20 mass% or more and 70 mass% or less. Therefore, the coating films formed using these coating compositions have good antifouling properties and also have good transparency. The coating compositions of Examples 12 and 13 contain the fluororesin particles in a range of 5 mass% or more and 50 mass% or less with respect to the silica fine particles, and thus have good antifouling properties and good transparency. Similarly, the coating compositions of Examples 14 and 15 contain the nonvolatile hydrophilic organic substance, the contents of the nonvolatile hydrophilic organic substance with respect to the silica fine particles being in a range of 10 mass% or more and 40 mass% or less, and thus have good antifouling properties and transparency.

The coating film formed on the acrylic substrate in Example 16 and the coating film formed by spray application in Example 17 also have good antifouling properties and transparency. That is, the coating films have good antifouling properties and transparency regardless of whether the substrate is glass or acrylic. The coating films formed by application using the nonwoven fabric and the coating film formed by spray application both have good antifouling properties and transparency.

On the other hand, as illustrated in FIG. 13, Comparative Examples 1 and 2 are evaluated to have low transparency. This is considered to be due to the amounts of the high-boiling-point solvent added, which are insufficient, thereby preventing the effect of forming a uniform film from being sufficiently obtained. Comparative Examples 3 and 4 are evaluated to have low transparency and antifouling properties. This is considered to be due to the amounts of the high-boiling-point solvent added, which are excessive, thereby reducing the dispersibility of the silica fine particles, and increasing the unevenness of the surfaces of the coating films.

Comparative Example 5 is evaluated to have low transparency. This is considered to be due to the boiling point of ethanol used as a solvent, which is 87° C. and is lower than the boiling points of other high-boiling-point solvents. Since the solvent having a boiling point of 171° C. is used in Example 7, it is considered that a coating film excellent in an antifouling property and transparency can be obtained when the boiling point of the high-boiling-point solvent is 150° C. or higher. A solvent is more likely to remain in the coating film when the boiling point thereof exceeds 300° C., so that it is considered to be preferable to use a high-boiling-point solvent having a boiling point of 300° C. or lower.

Comparative Examples 6 to 9 are evaluated to have low transparency or low antifouling properties. This is considered to be due to too large average particle size of the silica fine particles, or too small or too large amount of the silica fine particles added.

Comparative Example 10 is evaluated to have low transparency. This is considered to be due to the amount of the fluororesin particles added, which is excessive, thereby making dust more prone to adhesion. Considering that the content of the fluororesin particles with respect to the silica fine particles is 40 mass% in Example 13, it is considered that the amount of the fluororesin particles added is desirably 50 mass% or less.

Comparative Example 11 is evaluated to have a low antifouling property. This is considered to be due to the amount of the nonvolatile hydrophilic organic substance added, which is excessive, thereby making the coating film too soft.

### Examples in Which Coating Composition is Applied to Article

### Example 18

The coating composition of Example 1 is spray-applied to an outside of a glass lens of an outdoor camera, and natural drying is performed at 25° C. for 24 hours.

### Example 19

The coating composition of Example 1 is impregnated into a nonwoven fabric (manufactured by Kuraray Kuraflex Co., Ltd., product name: KURACLEAN Wiper, fiber used: rayon) and the nonwoven fabric is fixed to a block made of polycarbonate. A surface of the nonwoven fabric is brought into close contact with an acrylic cover of a lighting device and slid, and then natural drying is performed at 25° C. for 24 hours to form a coating film.

### Example 20

The coating composition of Example 1 is impregnated into a nonwoven fabric (manufactured by Kuraray Kuraflex Co., Ltd., product name: KURACLEAN Wiper, fiber used: rayon) and the nonwoven fabric is fixed to a block made of polycarbonate. A surface of the nonwoven fabric is brought into close contact with an outer surface of a housing of a room air conditioner and slid, and then natural drying is performed at 25° C. for 24 hours to form a coating film.

In Examples 18 to 20, the coating films are formed on corresponding substrates, but there was no change in the appearance of the substrates. That is, the coating films formed in Examples 18 to 20 have high transparency. In addition, under the conditions of a temperature of 25° C. and a humidity of 50%, Kanto loam dust which is a JIS test powder having a central particle size in a range of 1 µm or more and 3 µm or less is blown with air, and then each article is lightly shaken. As a result, the dust falls from each of the articles on which the coating films of Examples 18 to 20 are formed, and therefore it can be seen that the coating films formed in Examples 18 to 20 have high antifouling properties.

The configurations described in the above embodiments are merely examples, and can be combined with other known technology, the embodiments can be combined with each other, and part of the configurations can be omitted or modified without departing from the gist thereof.

### Reference Signs List

10 coating film; 10A liquid film; 11 silica fine particle layer; 12 fluororesin particle; 13 crack; 14 nonvolatile hydrophilic organic substance; 15 silica fine particle; 16 solvent; 20 substrate; 30 block; 31 cloth-like object; 100 camera; 110, 310 housing; 111 camera main body unit; 112 lens; 200 lighting device; 210 main body unit; 211 light cover; 300 air conditioner.

1. A coating composition comprising:
silica fine particles having an average particle size of 3 nm or more and 25 nm or less;
a solvent having a boiling point of 150° C. or higher and 300° C. or lower; and
water, wherein
a content of the silica fine particles is 0.1 mass% or more and 5 mass% or less, and
a content of the solvent is 20 mass% or more and 70 mass% or less.

2. The coating composition according to claim 1, further comprising fluororesin particles of which a content is 5 mass% or more and 50 mass% or less with respect to the silica fine particles.

3. The coating composition according to claim 1, further comprising a nonvolatile hydrophilic organic substance of which a content is 10 mass% or more and 40 mass% or less with respect to the silica fine particles, the nonvolatile hydrophilic organic substance being an organic substance being nonvolatile and hydrophilic.

4. A coating film formed on a substrate by the coating composition according to claim 1, the coating film comprising:
a silica fine particle layer disposed on the substrate and formed by aggregation of the silica fine particles.

5. A coating film formed on a substrate by the coating composition according to claim 2, the coating film comprising:
a silica fine particle layer disposed on the substrate and formed by aggregation of the silica fine particles, wherein
the fluororesin particles are disposed in a state of being partially exposed on a surface of the coating film and being dispersed in the silica fine particle layer.

6. A coating film formed on a substrate by the coating composition according to claim 3, the coating film comprising:
a silica fine particle layer disposed on the substrate and formed by aggregation of the silica fine particles, wherein
the nonvolatile hydrophilic organic substance is filled in a defect in the silica fine particle layer.

7. The coating film according to claim 4, having a film thickness of 20 nm or more and 250 nm or less.

8. The coating film according to claim 4, wherein the substrate is glass or a transparent resin.

9. An article comprising the coating film according to claim 4.

10. An optical device comprising a lens, the optical device comprising
the coating film according to claim 4 on a surface of the lens.

11. A lighting device comprising a light cover, the lighting device comprising
the coating film according to claim 4 on a surface of the light cover.

12. An air conditioner comprising a housing covering a main body that supplies and exhausts air to and from a room, the air conditioner comprising:
the coating film according to claim 4 on a surface of the housing.

13. A method for producing a coating film, comprising:
claim 1 onto a substrate to form a liquid film; and
drying the liquid film.

14. The method for producing a coating film according to claim 13, wherein in forming the liquid film, a cloth-like object impregnated with the coating composition is fixed to a coater having a face of which a shape follows a surface of the substrate, and the coater is slid along the surface of the substrate in a state where the cloth-like object is in close contact with the surface of the substrate to thereby form the liquid film.
